(19) United States
(12) Patent Application Publication
(10) Pub. No.: US 2008/0200084 A1
(43) Pub. Date: Aug. 21, 2008

(54) COMPOSITIONS FOR THIN CIRCUIT MATERIALS, CIRCUITS, MULTI-LAYER CIRCUITS, AND METHODS OF MANUFACTURE THEREOF

(76) Inventors: Richard O. Angus, Moosup, CT (US); Carlos L. Barton, Brooklyn, CT (US); David H. Guo, Pomfret Center, CT (US)

Correspondence Address: CANTOR COLBURN, LLP, 20 Church Street, 22nd Floor, Hartford, CT, 06103, US

(21) Appl. No.: 12/031,310

(22) Filed: Feb. 14, 2008

Related U.S. Application Data
(60) Provisional application No. 60/890,258, filed on Feb. 16, 2007.

(51) Int. Cl. B32B 5/02; C08G 59/00; C08G 75/00; C08G 73/00; B32B 37/00; B32B 15/08; B05D 3/02; B32B 27/38; C08K 3/22; C08K 3/10; C08K 3/32

(52) U.S. Cl. 442/59; 528/403; 528/373; 528/367; 528/422; 524/610; 524/401; 524/80; 524/413; 524/436; 524/612; 524/414; 156/60; 428/413; 428/418; 428/332; 427/386

(57) ABSTRACT

A composition for the manufacture of a circuit material comprises a solvent composition having a boiling point below 160° C.; an epoxy compound having an average epoxy functionality of greater than one, an epoxy equivalent weight of less than about 6,000 Daltons, a softening point of less than about 160° C., and solubility in the solvent composition; an aromatic polymer co-curable with the epoxy compound, and soluble in the solvent composition; and, optionally, a catalyst for the polymerization of epoxy groups. The composition for the manufacture of a circuit material can further comprise a filler additive and/or a flame retardant additive.

### BACKGROUND

The present invention relates to compositions useful in the formation of electrical circuit components, circuit materials and multi-layer circuits and more particularly to solvent soluble compositions that easily dry to solvent-free coatings at relatively low temperature and cure at temperatures commonly used in epoxy circuit board processing.

In electronic circuitry, electronic signals commonly are carried on metal conductors; individual conductors are electronically insulated from each other by dielectric materials. An exemplary dielectric material for circuits is polyimide, such as KAPTON® manufactured by DuPont. Circuit patterns can be created by many techniques, including etching the desired pattern in a thin copper foil layer attached to the dielectric or direct metallization on a dielectric substrate.

In multilayer circuit constructions, the layers must be bound together to form a single unit. This usually is accomplished by bonding with thin layers of a thermosetting adhesive material such as an acrylic or epoxy adhesive. The adhesive may be applied as a solution, as a solvent-free liquid mixture, or as a solvent-free film of adhesive. The solution, once applied to the substrate, requires removal of the solvent. The adhesives thus applied are cured to form the bonds that hold the multilayer circuit board together. Curing the adhesive usually is accomplished thermally (at 150 to 200° C.) or photochemically.

In the completed circuit the layer most susceptible to chemical attack and thermal decomposition is the epoxy or acrylic layer, either of which can lead to delamination of a multilayer circuit upon chemical contact or high temperature. Additionally, the low glass transition temperature (Tg) typical of epoxy and acrylic adhesives limits the maximum use temperature of the circuit.

When preparing the bonding layer by coating an acrylic or epoxy adhesive solution on a circuit layer substrate and removing the solvent to dry the thin film, the dried film often has a tacky surface. Partial curing of the adhesive, often called B-staging, advantageously may be incorporated into the process to reduce the tackiness of the surface and afford additional strength to the adhesive layer.

Intermediate components used in the manufacture of multilayer circuit board include many different constructions that contain dried or B-staged acrylic or epoxy adhesive layers. These include free (or carrier supported) films of the adhesive, pre-pregs composed of a fibrous support imbedded within a layer of the adhesive, coverfilms comprising a dielectric film coated with or otherwise adhered to the adhesive, and resin-coated foils, wherein a conductive metal foil such as copper is coated with or otherwise adhered to the adhesive.

Other intermediate components used in the manufacture of multilayer circuit boards contain one or two cured adhesive layers, for example, single sided (SS) conductive metal-clad laminates, which comprise a dielectric film and a conductive metal foil layer bonded with a thin acrylic or epoxy adhesive layer, or double-sided (DS) conductive metal-clad laminates, which comprise a dielectric film with a thin acrylic or epoxy adhesive layer on each side to bond a conductive metal layer to each side of the film.

While suitable for some applications, acrylic and epoxy adhesives used for printed circuits are sometimes deficient in the following areas: their Tg is too low to allow certain fabrication and assembly processes at elevated temperatures or allow satisfactory use at higher maximum temperatures; their dimensional stability is poor due to low Tg and high CTE of the adhesive, their thermal stability is too low to meet lead free solder requirements or to allow good long term service; dried coatings of the adhesive sometimes are tacky; adhesive flow upon cure may be excessive and their chemical stability is too low for some operating environments.

Another category of multilayer circuits components are adhesiveless materials. Adhesiveless intermediate components useful in the manufacture of multilayer circuit boards include those wherein a layer of dielectric is adhered to a conductive copper foil, and those wherein a layer of dielectric is bound on each side by a conductive layer. These constructions can be prepared either by laminating the dielectric foil to a dielectric film or coating, drying and curing a liquid dielectric formulation onto a copper foil.

One group of adhesiveless circuit materials includes all-polyimide laminates, which can be prepared by coating and/or laminating a polyimide dielectric layer and a conductive metal layer. In the coating approach, a polyamide-acid solution in an aprotic, highly polar, high boiling solvent is coated onto, e.g., a copper foil; the coated foil is warmed, evaporating enough solvent to make a tack-free coating, and heated to a higher temperature in order to thermally imidate the polyamide-acid (thus converting it to the polyimide). The polyimide thus formed is not soluble in the original solvent. In the laminating approach, a sheet of, e.g., a copper foil (often with a surface treatment that introduces a controlled amount of surface roughness) is brought into intimate contact with a polyimide film. Lamination is conducted at a suitable pressure, and a temperature above the Tg of the polyimide effective to cause the dielectric polyimide to flow into the valleys of the surface of the copper foil. In some processes two or more layers of polyimide are used wherein one layer has a Tg above the lamination process conditions while the surface layer has a Tg below the lamination pressure.

The main advantages of an all-polyimide material over a conventional adhesive based circuit material include: thinner laminate material that allows better flexibility and smaller parts, superior dimensional stability that allows finer pitches, higher densities and thus smaller sizes of the circuits, better thermal stability that allows the resistance of the circuit materials to thermal decomposition, and the like. However, a drawback of the all-polyimide materials is the necessity for high temperature processing. The imidation process, converting the polyamide acid to form polyimide, typically requires temperatures above 200° C. and removal of the last traces of aprotic polar solvents usually is accomplished near 300° C. The thermal processing time is longer than desired, which adds significantly to the cost of production of these circuit components.

There is accordingly a long-felt need in the electronics industry for an adhesive composition without the chemical, thermal, dimensional stability, Tg and CTE limitations of an acrylic or epoxy adhesive. It would further be an advantage if the adhesive were without the difficulties associated with use of an aprotic, highly polar, high boiling solvent and high temperature processing of a polyimide system. It would also be advantageous if the adhesive layer was flexible and had good mechanical properties (e.g., modulus, tensile strength, and/or tear strength), especially in the form of a fully cured, unsupported layer. It further would be advantageous for the composition to be flame retardant, for example passing the UL94 test with a V-0 or a VTM-0 rating.

What is also needed in the art are new compositions for the formation of dielectric layers useful in the manufacture of multilayer circuits. It would be advantageous if the compositions could be used without an acrylic or epoxy adhesive. It would further be advantageous if the dielectric layers formed from the compositions were more chemically and thermally stable, had higher Tg and lower CTE than acrylic or epoxy adhesives. It would also be an advantage if the dielectric layers were tack-free after drying and had controlled flow during lamination curing.

### SUMMARY

These and other disadvantages of the art are alleviated by a composition for the manufacture of a circuit material, comprising a solvent composition having a boiling point below 160° C.; an epoxy compound having an average epoxy functionality of greater than one, an epoxy equivalent weight of less than about 6,000 Daltons, a softening point of less than about 160° C., and solubility in the solvent composition; an aromatic polymer co-curable with the epoxy compound, and soluble in the solvent composition; and, optionally, a catalyst for the polymerization of epoxy groups. The composition for the manufacture of a circuit material can further comprise a filler additive and/or a flame retardant additive.

In a specific embodiment, a composition for the manufacture of a circuit material comprises about 10 to about 90 wt. % of a solvent composition having a boiling point below 160° C.; and about 10 to about 90 wt. % of a curable composition, each based on the combined weight of the solvent composition and the curable composition, wherein the curable composition comprises, based on the total weight of the curable composition, about 5 to about 40 wt. % of an epoxy compound soluble in the solvent composition and having an average epoxy functionality of greater than one, an epoxy equivalent weight of less than about 6,000 Daltons, and a softening point of less than about 160° C.; about 60 to about 95 wt. % of an aromatic polymer co-curable with the epoxy compound and soluble in the solvent composition; and, optionally, a catalyst for the polymerization of epoxy groups and/or a flame retardant and/or a filler.

Further described herein is a B-staged adhesive and a dielectric material suitable for use in electronic circuits, formed by removing the solvent composition and partially curing the above-described composition for the manufacture of a circuit material.

Further described herein is an adhesive and a dielectric material suitable for use in electronic circuits, formed by removing the solvent composition and fully curing the above-described composition for the manufacture of a circuit material.

A method of forming a circuit material comprises forming a film comprising the above-described composition for the manufacture of a circuit material onto a substrate, removing the solvent from the film, and curing the film. In one embodiment the film is B-staged during or after removal of the solvent. In another embodiment, the B-staged film is fully cured. Full cure can be effected by lamination of the partially cured film and a conductive layer at a temperature appropriate for curing the curable composition.

In still another embodiment, a method of forming a circuit material comprises metallizing the above-described fully cured film.

### BRIEF DESCRIPTION OF THE DRAWINGS

FIG. 1 is a schematic drawing of a circuit material.

FIG. 2 is a schematic drawing of a circuit material.

FIG. 3 is a schematic drawing of a circuit material.

FIG. 4 is a schematic drawing of a circuit material.

FIG. 5 is a schematic drawing of a circuit material.

### DETAILED DESCRIPTION

The inventors hereof have unexpectedly found that certain combinations of aromatic polymers and epoxy compounds can be made into homogeneous solutions, coated onto substrates, and dried to form tack-free, homogeneous films. These films further can be cured to provide a homogenous polymeric matrix. The homogeneity of the cured matrix is demonstrated by the observation of a single Tg. It has been found that these cured hybrid polymers have thermal resistance, higher Tg, and lower CTE than cured acrylic or epoxy compositions. The mechanical properties of the hybrid polymers are further far superior to those of a cured acrylic or epoxy compositions. This combination of properties renders the hybrid polymers excellent for use in electronic circuits.

In particular, films comprising the hybrid polymers are formed by dissolving a curable composition (a co-curable aromatic polymer, an epoxy compound, and an optional catalyst) in a solvent composition. The epoxy compound has average epoxy functionality of greater than one, an epoxy equivalent weight of less than about 6,000 Daltons, and a softening point of less than about 160° C. in a solvent composition. The solvent composition comprises one or more solvents, and has a boiling point of less than 160° C. After forming a film, the solvent is removed, and the film is partially or fully cured. Such films can be used to form a variety of circuit materials useful in the manufacture of thin, multilayer circuits.

A wide variety of aromatic polymers can be used in the curable composition of the composition for the manufacture of a circuit material. Suitable aromatic polymers are thermoplastic, and soluble in the solvent composition, i.e., have a solubility sufficient to provide a homogenous mixture at a concentration and temperature useful for film formation. In one embodiment, the aromatic polymer has a solubility of greater than about 20% at 25° C. (w/v), specifically greater than 30% at 25° C. (w/v), even more specifically greater than 40% at 25° C.

In addition to solubility, suitable aromatic polymers are co-curable with the epoxy compound. As used herein, “co-curable” means that the aromatic copolymers will form a homogenous polymeric matrix after complete cure of curable composition comprising the aromatic polymer and the epoxy compound. A homogenous polymeric matrix will have a single Tg, determined using dynamic mechanical analysis (DMA).

Formation of a homogenous polymeric matrix is more likely when the aromatic polymer and the epoxy compound chemically react during cure. Suitable aromatic polymers can accordingly have at least one epoxy-reactive group. Exemplary epoxy-reactive groups include primary amines, secondary amines, isocyanates, hydroxyls, carboxylic acids, orthoesters, carboxylic acid chlorides, carboxylic acid anhydrides, mercaptans, thiiranes, epoxides, carbodiimides, oxazolines, oxiranes, acetoacetates, acetonitriles, acetylenes, aldehydes, alkyl halides, alkyl hydroperoxides, amides, cyanates, cyanoacetates, ketones, malonates, phenols, phosphines, phosphoric acid, phosphorous acid, phosphates, phosphinates, and aziridines. In one embodiment, more than one epoxy-reactive group is present per polymer molecule.

It is further advantageous if the co-curable aromatic polymer has a Tg of less than about 200° C., specifically a Tg of about 100 to about 175° C., even more specifically a Tg of about 100 to about 150° C.

Possible thermoplastic aromatic polymers include aromatic poly(sulfone)s, poly(ethersulfone)s, aromatic poly(imide)s, aromatic poly(amide)s, aromatic poly(amideimide)s, poly(arylene ether)s such as poly(phenylene ether), poly(phenylquinoxaline)s, poly(quinoline)s, poly(arylene ether ketone)s, poly(arylene ether sulfone)s, poly(arylene ether phosphone)s, poly(phosphines), aromatic polycarbonates and aromatic poly(ester)s.

Among these, aromatic polyimides, aromatic poly(amide)s, and aromatic poly(amide-imide)s oligomers are particularly useful. A variety of monomers and polymerization strategies for such oligomers may be found in EP 0 319 008, which is incorporated herein by reference.

The foregoing polymers are rendered “aromatic” by the presence of at least one repeating structural unit in the polymer that contains an aromatic group. The aromatic groups can be monocyclic or polycyclic. The aromatic groups can further contain only carbon in the backbone, or a combination of carbon and one or more heteroatoms such nitrogen, sulfur, phosphorus, and/or oxygen.

In one embodiment, all of the repeating structural units in the aromatic polymer contain an aromatic group. Exemplary polymers of this type include poly(ether ether ketone). In other embodiments, only a portion of the repeating structural units in the aromatic polymer contain an aromatic group. Exemplary polymers of this type include alternating or block copolymers derived from the reaction of nitrile rubber with polyamideimide or polyamide. Examples of such a block copolymer are discloses in EP 1 333 077. Other possible polymer structural repeat units for use in the copolymer include styrene maleic anhydride (SMA).

The epoxy compounds can be monomeric, oligomeric, or polymeric, provided that the compound has average epoxy functionality of greater than one, preferably greater than about 2, more preferably about 1.7 to about 5. Suitable epoxy compounds further have an epoxy equivalent weight of less than about 6,000 Daltons, preferably about 170 to about 5,000 Daltons, more specifically about 170 to about 3,000 Daltons, even more specifically about 170 to about 1,000 Daltons. In addition, the epoxy compounds have a softening point of less than about 160° C., preferably about room temperature to about 140° C., more preferably about room temperature to about 125° C. Suitable epoxy compounds are soluble in the solvent composition, i.e., have a solubility sufficient to provide a homogenous mixture at a concentration and temperature useful for film formation. In one embodiment, the epoxy compound has a solubility of greater than about 50% at 25° C. (w/v), specifically greater than 60% at 25° C. (w/v), even more specifically greater than 80% at 25° C.

Useful epoxy compounds include certain novolac and resole resins; the diglycidyl ethers of dihydroxy compounds such as hydroquinone, resorcinol and catechol; diglycidyl ethers of bisphenols such as bisphenol A (BPA), bisphenol F (BPF) and bisphenol S (BPS); the triglycidyl ethers of aminophenols such as m- and p-aminophenol; and the tetraglycidyl ethers of aromatic diamines such as 4,4′-methylene dianiline (4,4′-MDA) and 3,3′-methylene dianiline (3,3′-MDA), 4,4′-diaminodiphenylsulfone (4,4′-DDS), 3,3′-diaminodiphenylsulfone (3,3′-DDS). Other exemplary epoxy compounds are described in U.S. Pat. No. 3,700,617, and by Wang, T-S, Yeh, J-F, Shau, M-D in J. Applied Polymer Sci., 1996, 59, 215-25, both of which are incorporated herein by reference.

Novolac resins and the diglycidyl ethers of bisphenol A can be specifically mentioned. These resins are commercially available, and include the EPON resins, such as an epoxy o-cresol novolac with functionality of 4.1 available under trade name EPON-164 from Hexion Specialty Chemicals); and the diglycidyl ethers of bisphenol A available under the trade name DER332 from Dow Chemical. Mixtures of two or more epoxy compounds can also be used.

The relative amount of the epoxy compound and the aromatic polymer in the curable composition can vary, depending on the reactivity of the components, the desired properties in the cured composition, and like considerations. In general, the curable composition comprises about 5 to about 50 wt. %, specifically about 5 to about 40 wt. % of the epoxy compound, and about 50 to about 95 wt. %, specifically about 60 to about 95 wt. % of the aromatic polymer.

A catalyst effective for the polymerization of epoxy compounds can be present as part of the curable composition. Exemplary catalysts of this type include amines, for example tertiary amines, aromatic heterocyclic amines such as imidazoles (including alkyl-substituted imidazoles), and cyano-modified guanidines (such as dicyandiamide) and amidines. A combination comprising one or more of the foregoing types of catalysts can be used, for example a combination of an alkyl-substituted imidazole and a dicyandiamide. When used the catalyst is present in the curable compositions in an amount of about 0.25 to about 8 wt. % of the epoxy portion of the curable composition, specifically about 0.1 to about 4 wt. %.

In one embodiment, the catalyst is a latent cure catalyst that is activated by, e.g., heat. For example, the catalyst can be encapsulated in a shell that isolates the catalytic species from the remainder of the formulation until sufficient temperature is reached to allow rupture of the shell. The encapsulated catalyst can be any of the foregoing catalysts. Exemplary encapsulated catalysts include a primary or secondary amine.

A wide variety of solvents and solvent mixtures can be used in the solvent composition, provided that the solvent composition has a boiling point of less than 160° C., specifically about 80 to 160° C. Exemplary solvents include cyclohexanone, toluene, methyl ethyl ketone (MEK), methanol, 2-ethoxyethanol acetate, dimethyl formamide, 1-methoxy-2-propyl acetate, 1-methoxy-2-acetoxypropane, methoxypropyl acetate, propylene glycol monomethyl ether, 1-methoxy-2-propanol acetate, iso-amyl acetate, xylene, ethylbenzene, chlorobenzene, cyclopentanone, n-butyl acetate, ethylene glycol diethyl ether, 1-methoxy-2-propanol, n-butanol, iso-butanol, n-propyl acetate, 1,4-dioxane, 3-pentanone, 1,1,2-trichloroethylene, 1,2-dichloroethane, iso-propanol, benzene, ethyl acetate, 1,3-dioxolane, 1,1,1-trichloroethylene, tetrahydrofuran, chloroform, methyl acetate, acetone, methylene chloride, diethyl ether, dimethyl ether, among others.

Fillers, in particular particulate dielectric fillers, can be present in the composition for the manufacture of a circuit material to adjust the properties thereof, for example the electrical properties and/or the coefficient of thermal expansion (CTE). Useful particulate fillers include, but are not limited to, titanium dioxide (rutile and anatase), barium titanate, strontium titanate, silica, including fused amorphous silica and sol-gel nano-sized silica fillers, corundum, wollastonite, aramide fibers (e.g., KEVLAR™ from DuPont), fiberglass, glass spheres, quartz, boron nitride, aluminum nitride, silicon carbide, metal oxides such as beryllia, alumina, magnesia, magnesium hydroxide, Ba₂Ti₉O₂₀, and fumed silicon dioxide (e.g., Cab-O-Sil, available from Cabot Corporation), mica, talcs, nanoclays, and metal silicates such as aluminosilicates (natural and synthetic). The particulate fillers may be used alone or in combination. Particularly useful particulate fillers are rutile titanium dioxide and amorphous silica because these fillers have a high and low dielectric constants, respectively, thereby permitting a broad range of dielectric constants combined with a low dissipation factor to be achieved in the final product by adjusting the respective amounts of the two fillers in the composition. Silica, including sol-gel nano-sized silica fillers, and talc are useful to reduce the CTE and improve electrical properties at the same time. To improve adhesion between the fillers and hybrid polymer, the filler can be treated with one or more coupling agents, such as silanes, zirconates, or titanates. The total amount of dielectric particulate filler, when present, is generally about 0.1 to about 50 parts by weight (pbw) per 100 pbw of the curable composition. Specific amounts are about 0.5 to about 35 pbw, and even more specifically about 1 to about 20 pbw per 100 pbw of the curable composition.

Other additives can be present as part of the curable composition, for example flame retardants, ultraviolet light absorbers, thermal stabilizers, antioxidants, pigments, rheology modifiers, dispersants, surfactants, tackifiers or anti-tackifiers, and the like. A combination comprising one or more of the foregoing additives can be used. The additives are present in the amounts ordinarily used for circuit materials, e.g., about 0.01 to about 5 wt % of the curable composition.

In a specific embodiment, a flame retardant is not included in the composition for the manufacture of a circuit material. In another embodiment, a flame retardant is included in an amount sufficient to allow the cured specimen to pass the UL 94 vertical burn test with a V-0 or VTM-0 rating. The total amount of flame retardant included in the specimens will vary with different flame retardants with amounts generally between about 0.1 to about 40 pbw per 100 pbw of the curable composition. An exemplary flame retardant is the aluminum phosphinate available under the trade name EXOLIT OP930 and OP935 from Clariant Corporation. Specific amounts of OP935 are about 5 to about 35 parts by weight (pbw) per 100 pbw of the curable composition, and even more specifically between about 10 and about 25 pbw per 100 pbw of the curable composition.

In practice, the circuit materials are formed by first dissolving the elements of the curable composition (aromatic polymer, epoxy compound, optional catalyst) in the solvent composition, together with any additional additives, to provide a film-forming solution. The solvent can be heated to aid in dissolution. However, the mixing temperature is regulated to avoid substantial decomposition, crosslinking, or other reaction of the components. Mixing continues until all components are uniformly dispersed throughout the composition. Any particulate filler may be treated with silanes for more efficient use of the agents. Optionally, silanes may be included in the composition.

The relative amount of the curable composition and the solvent composition in the film-forming solution can vary, depending on the solubility of the components, the boiling point of the solvent, and like considerations. In general, the film-forming solution comprises about 10 to about 90 wt. %, specifically about 50 to about 85 wt. % of the solvent composition having a boiling point below 160° C.; and about 10 to about 90 wt. %, specifically about 15 to about 50 wt. %, of the curable composition, each based on the combined weight of the solvent composition and the curable composition. Where possible, lower amounts of solvent are used.

The film-forming solution is cast or coated onto a substrate to form a layer by methods known in the art (e.g., casting, spin coating, transfer coating, or like processes). The thickness of the layer after removal of solvent will depend on the desired application, and can be, for example, about 1 to about 100 micrometers, more specifically about 5 to about 50 micrometers. The layer can be formed on a release layer, or coated directly onto a conductive layer or other polymeric dielectric layer.

Suitable release layers include, for example, polyethylene, polypropylene, polyethylene terephthalate resins, and the like coated, for example, with a silicone-based releasing agent, as well as paper sheets coated with a polyethylene, or polypropylene. Other types of substrate layers include thin dielectric films such as polyimide (available from DuPont under the trade name KAPTON, and from Kaneka Corporation under the trade name APICAL), and polyesters such as a polyethylene terephthalate (for example, MYLAR from DuPont).

Useful conductive layers include stainless steel, copper, aluminum, zinc, iron, transition metals, and alloys comprising at least one of the foregoing, with copper specifically useful. There are no particular limitations regarding the thickness of the conductive layer, nor are there any limitations as to the shape, size or texture of the surface of the conductive layer. Specifically however, the conductive layer has a thickness of about 1 micrometer to about 200 micrometers, with about 9 micrometers to about 72 micrometers especially useful. When two or more conductive layers are present, the thickness of the two layers may be the same or different.

Copper conductive layers are especially useful. The copper conductive layer can be treated to increase surface area, treated with a stabilizer to prevent oxidation of the conductive layer (i.e., stainproofing), or treated to form a thermal barrier. Such copper conductive layers are available from, for example, Nikko Material Co. under the name “BHY-22BT”, Olin Corporation under the name of “CopperBond” and “CopperBond XTF”, Oak-Mitsui under the trade name “TOC-500” and “TOC-500-LZ” (low profile copper foils); Oak Mitsui under the trade name SQ-VLP and TQ-VLP (electrodeposited foils); and Circuit Foil under the trade name “TWS” (high profile copper foils).

In another embodiment, both electrically and thermally conductive layers can be used, for example thicker, heat conductive metal bars such as are used for heat dissipation.

The film-forming solution can also be cast onto or otherwise used to impregnate a fibrous support, that is, a woven or nonwoven web. The fibrous support can be glass, polyamide, or other fibrous material. The fibrous support can itself be supported by a release or other layer.

The layer is then heated to remove solvent. In one embodiment, the film is heated at a temperature effective to evaporate the solvent, but not substantially cure the film. In another embodiment, the film is heated at a temperature effective to evaporate the solvent, and partially cure (B-stage) the film. B-staged films are tack-free, and have enough mechanical strength for handling, but also have enough unreacted functional sites that they can be further cured to provide the full and final physical polymer properties. Temperatures and times effective for solvent removal and B-staging will depend on the solvent used and the reactivity of the curable composition. Exemplary conditions for B-staging the layers are temperatures of about 80 to about 130° C. for about 15 to about 300 minutes, specifically about 90 to about 120° C. for about 20 to about 180 minutes, and most specifically about 90 to about 110° C. for about 30 to about 90 minutes.

The B-staged films can be stored prior to further processing. Further processing generally includes full cure of the films. For example, the B-staged film can be fully cured on a release liner and the liner removed after cure to provide a film of fully cured hybrid polymer. Alternatively, the B-staged films can be bonded to another B-staged layer, another dielectric substrate layer, or a layer of a conductive metal. Full cure can be done in a conventional oven, or in a press or an autoclave under heat and pressure. Exemplary conditions for cure are temperatures of about 120 to about 220° C. and pressures of about 50 to about 500 psi, preferably about 140 to about 200° C. and about 150 to about 400 psi, and most preferably about 150 to about 200° C. and about 250 to about 350 psi.

Alternatively, or in addition, the B-staged or fully cured films can be laminated to an adhesive layer to form circuit materials, circuits, and multilayer circuits. Lamination using either B-staged or fully cured film entails layering the film with another circuit material to form a stack, and laminating the stack under heat and pressure, e.g., under the conditions described above.

After full cure, the films are generally about 2 to about 100 micrometers thick, preferably about 5 to about 50 micrometers thick, more preferably about 5 to about 25 micrometers thick.

The B-staged and fully cured hybrid polymer compositions have a number of advantageous properties. The B-staged films are non-tacky, and stable upon storage.

The Tg of the fully cured hybrid polymers is higher than the Tg of conventionally cured epoxies and lower than that of polyimides, rendering them suitable for the manufacture of electronic circuit materials and circuits. In one embodiment, the cured hybrid polymer has a single Tg of greater than about 150° C., specifically a Tg of about 160° C. to about 185° C., even more specifically a Tg of about 175° C. to about 200° C.

The cured hybrid polymer compositions can also have an elongation of greater than about 10%, specifically greater than about 5%. The cured polymer can have a tear initiation value (measured in accordance with IPC-TM-650 §2.4.16) of greater than about 400 gf, specifically greater than about 600 gf.

In another embodiment, the cured hybrid polymer compositions pass IPC chemical resistance test IPC-TM-650 §2,3,2.

The cured hybrid polymer compositions further have good adhesion to copper, for example a peel strength of about 5 to about >10 pounds per linear inch (pli), measured in accordance with IPC-TM-650 §2.4.9.

In still another embodiment, the cured compositions have a CTE of lower than 150 ppm/° C. measured over 30 to 150° C. in accordance with IPC TM-650 2.4.41.3, more specifically less than about 100 ppm/° C. and most specifically less than about 50 ppm/° C.

The B-staged and fully cured hybrid polymer films can be produced in a variety of forms useful for the manufacture of electronic circuit materials and circuits. In one embodiment, the B-staged or fully cured film, removed from a release layer, is used as a free film, for example as a bond ply, or in combination with other dielectric layers and/or conductive layers. Free films can incorporate a fibrous support as described above. In one embodiment, a copper-clad dielectric is prepared by direct metallization of a fully cured coating or freestanding thin film of the hybrid polymer.

The B-staged or fully cured hybrid polymer film can also be left adhered to the substrate, e.g., another dielectric layer or a copper foil, and used in the manufacture of electronic circuit materials and circuits. The dielectric layer can have the same composition as the B-staged layer, or a different composition. More than one B-staged layer can be present in an article.

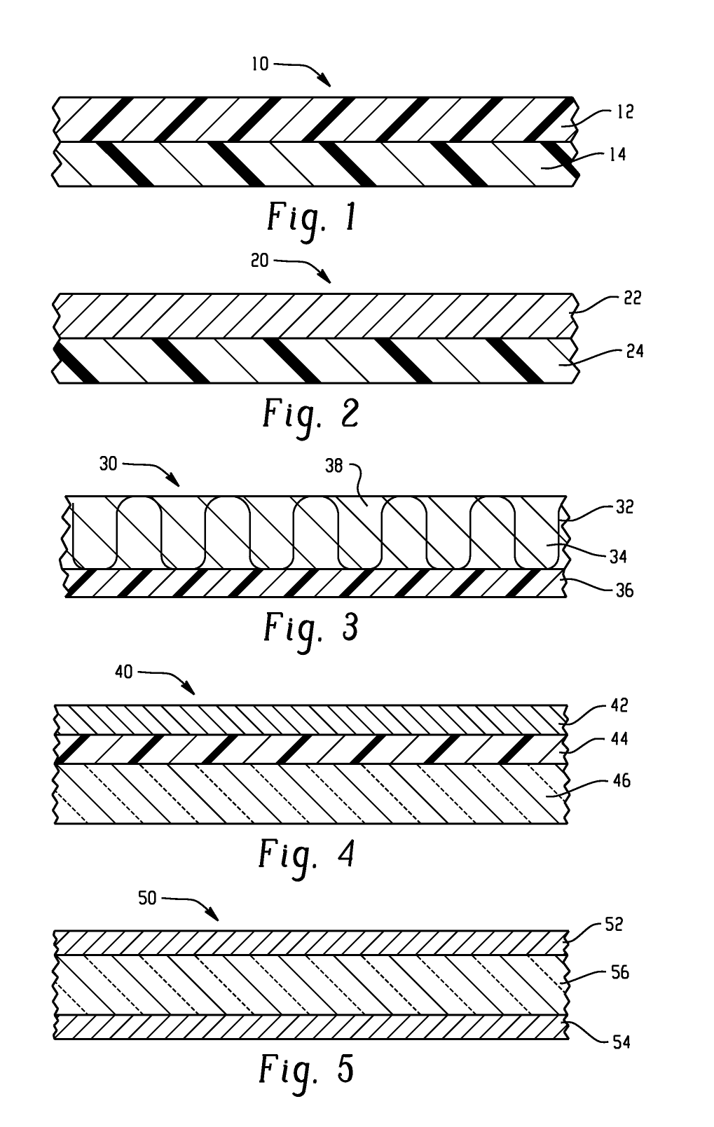

Specific articles that can be manufactured using the hybrid polymer compositions and processes described herein include cover films as shown in FIG. 1. A cover film can be prepared by coating a thin dielectric substrate film 12 with the film-forming composition to form a layer, removing the solvent, and advancing cure of the composition to the point of B-stage to provide a film 14. Alternatively, a homogeneous cover film construction is prepared by coating the film-forming composition onto a release substrate, removing the solvent, and fully curing the composition to provide a layer comprising the hybrid polymer, followed by coating the cured hybrid polymer composition with another layer of the film-forming composition, and B-staging the coating. Cover films can then be combined with other circuit materials and laminated to effect full cure of the compositions for the manufacture of a circuit material.

As shown in FIG. 2, a resin-coated copper foil 20 can be prepared by coating copper foil 22 with a layer of the film-forming composition, followed by solvent removal and B-staging the composition to provide a layer of a B-staged hybrid polymer composition 24. Alternatively, single-sided (SS) flexible copper-clad laminate (FCCL) can be prepared by coating, drying and fully curing the composition onto a thin copper foil.

As shown in FIG. 3, a prepreg 30 is prepared by coating and filling all pores of a fibrous reinforcing layer 32 such as a glass cloth (woven or non-woven) with the film-forming composition 34, and drying and B-staging the composition. As described above, a particulate filler additive 38 can be present in the hybrid polymer composition. The prepreg 30 can be formed on release layer 36.

Laminated products prepared using the compositions for the manufacture of a circuit material can be provided in a variety of forms. As shown in FIG. 4, a SS laminate 40 comprises a dielectric layer 46 adhered to a conductive layer 42 (e.g., a copper foil) using a layer of the hybrid polymer composition 44. Such SS laminates can be prepared by laminating a B-staged hybrid resin-coated dielectric layer to a copper foil, or by laminating a cured hybrid resin-coated copper foil to a dielectric thin film.

FIG. 5 shows a double sided (DS) flexible, copper-clad laminate 50 comprising two conductive metal foils 52 and 54 adhered to a dielectric layer 56. Such laminates can be prepared by a variety of methods, for example by laminating a resin-coated copper foil to a bare copper foil, wherein the resin comprises the hybrid polymer. In another embodiment, such laminates can be prepared by laminating together two resin-coated copper foils, resin-to-resin, wherein at least one of the resin layers comprises the hybrid polymer. In still another embodiment, such laminates can be prepared by laminating two copper foils 52, 54 to B-staged dielectric adhesive layers comprising the hybrid polymer that have been coated onto both sides of a fully cured dielectric thin layer or film. Alternatively, such laminates can be obtained by coating, drying, and B-staging a composition comprising the hybrid polymer onto a SS FCCL, and then laminating that structure onto an uncoated SS FCCL. In these last two embodiments, the dielectric layer 56 comprises three layers of a dielectric composition, wherein at least one layer comprises the hybrid polymer, and the three layers may or may not be the same composition.

The invention is further illustrated by the following non-limiting examples.

### EXAMPLES

The following materials were used in the Examples.

TABLE A

| Trade Name or Acronym | Material | Supplier |
|---|---|---|
| Vylomax ET001RJ | Polyamideimide, 35% resin content in 50/50 | Toyobo |
| (ET001) | toluene/ethanol | |
| Vylomax AT-002RJ | Polyamideimide, 35% resin content in 60/40 | Toyobo |
| (AT002) | cyclohexanone/toluene | |
| Vylomax ET007RJ | Polyamideimide, 25% resin content in | Toyobo |
| (ET001) | 14.7/60/25.3 dimethyl | |
| | acetamide/cyclohexanone/toluene | |
| Vylomax ET008RJ | Polyamideimide, 30% resin content in 70/30 | Toyobo |
| (ET001) | cyclohexanone/toluene | |
| Vylomax ET009RJ | Polyamideimide25% resin content in 50/50 | Toyobo |
| (ET001) | toluene/ethanol | |
| Nipol 1072 | Carboxy terminated butadiene-acrylonitrile | Zeon Chemicals |
| | rubber (CTBN), 25% solution in MEK | |
| Microtuff AG 609 | Surface treated talc filler | Mineral |
| | | Technologies |
| Nanopox E470 | Sol-gel nano-sized silica reinforced bisphenol | Nanoresins AG |
| | A epoxy concentrate with 40 wt % silica and 60 wt % | |
| | epoxy (50% solution in MEK) | |
| XU8282 | Benzoxazine resin (35% solution in MEK) | Huntsman |
| DER332 | Liquid epoxy, diglycidyl ether of bisphenol A | Dow Chemical |
| DER664 | Solid epoxy, poly diglycidyl ether of bisphenol | Dow Chemical |
| | A (50% solution in MEK) | |
| DER669 | Solid epoxy, poly diglycidyl ether of bisphenol | Dow Chemical |
| | A (50% solution in MEK) | |
| DER684 | Solid epoxy, poly diglycidyl ether of bisphenol | Dow Chemical |
| | A, 40 wt % in methyl ethyl ketone solution | |
| EPON-164 | Novolac Epoxy, o-cresylic novolac with a | Resolution |
| | functionality of about 4.1 (50% solution in | Performance |
| | MEK) | Products |
| DEN439 | Novolac Epoxy, o-cresylic novolac with a | Dow Chemical |
| | functionality of about 3.8 | |
| BPAM-01H | Polyamide/nitrile rubber block copolymer as | |
| | described in EP 1 333 077 | |
| Gharda Gafone 3600RP | Polyether sulfone with reactive termini | Gharda |
| Solvay Gafone 3600 RP | Polyether sulfone with reactive termini | Solvay |
| | | Advanced |
| | | Polymers |
| Radel A 105NT | Polyether sulfone with about ⅓ reactive | Solvay |
| | termini | Advanced |
| | | Polymers |
| DICY | Dicyandiamide, 25% nonvolatile in dimethyl | Aldrich |
| | formamide | |
| 2MI | 2-methylimidazole, 15% nonvolatile in | Aldrich |
| | dimethyl formamide | |
| Sig 5840 | Epoxy functional silane coupling agent | Gelest |
| EXOLIT OP935 | Aluminum phosphinate flame retardant | Clariant |
| | | Corporation |

### Example 1

A varnish solution was prepared following the formulation shown in Table 1 by mixing 200 g ET001, 86 g XU8282, 2 g 2-MI, and 4 g DICY in a glass bottle under shear. The varnish was coated onto either a 2 mil (51 micrometer) thick Teflon release sheet or a 1 mil (26 micrometers thick) APICAL polyamide film. The coated films were then dried in an oven at 90° C. for 10 minutes and then at 120° C. for 10 minutes. The dried adhesive layers were approximately 0.001 inch thick.

For all the examples listed in Table 1, specimens for thermal and tensile analyses were prepared by removing the dried adhesive film from the release carrier and plying a number of sheets of free film and laminating the stack between TEFLON® sheets in a press at 176° C. for 90 minutes at 300 psi. Then the samples were further baked in an oven at 220° C. for 2 hours. DMA analysis was performed by heating the specimen from 25° C. to 250° C. at 20° C./minutes. The storage modulus and tan delta curves were plotted against the temperature. The storage modulus (at 25° C.) and the Tg (peak tan delta) values are reported in Table 2. TMA analysis was performed following IPC TM 650 2.4.41.3 and the CTE was measured between 30 and 150° C.; the CTE values are reported in Table 2. Tensile testing was performed using dumbbell-shaped specimens with dimensions following ASTM D1708. The testing was performed following the ASTM D1708 procedure. Young's modulus, tensile strength, and elongation at break are reported in Table 2. For certain samples, the vertical burn tests were performed following UL94 VTM procedure. The results are reported in Table 2.

TABLE 1

| | Resins and Additives (g) | | | | | | |
|---|---|---|---|---|---|---|---|
| | | | | Exolit | | | |
| | ET- | | Nipol | OP | Sig | | |
| Example No. | 0001RJ | XU8282 | 1072 | 935 | 5840 | 2-MI | Dicy |
| Ex. 1 | 200 | 86 | | | | 2 | 4 |
| Comp Ex. 1 | 200 | 86 | 40 | | | 2 | 4 |
| Comp Ex. 1a | 200 | 86 | 80 | | | 2.7 | 4 |
| Ex. 2 | 228 | 57 | | | | 2.7 | 4 |
| Ex. 3 | 257 | 29 | | | | 2.7 | 4 |
| Ex. 4 | 257 | 29 | | | | 2 | 6 |
| Ex. 5 | 257 | 29 | | 20 | 0.3 | 2 | 6 |

### Comparative Example 1

A varnish was prepared by mixing 200 g ET001, 86 g XU8282, 40 g Nipol 1072, 2 g 2-MI, and 4 g DICY. The addition of Nipol 1072 rubber was to increase the flexibility. Specimens were prepared and analyzed as for example 1. The results are tabulated in Table 2.

### Comparative Example 1a

A varnish was prepared from 200 g ET001, 86 g XU8282, 80 g Nipol 1072, 4 g DICY, and 2.7 g 2 MI. Specimens were prepared and analyzed as for example 1. The results are tabulated in Table 2.

### Example 2

A varnish was prepared from 228 g ET001, 57 g XU8282, 4 g DICY, and 2.7 g 2 MI. Specimens were prepared and analyzed as for example 1. The results are tabulated in Table 2.

### Example 3

A varnish was prepared from 64.3 g ET001, 7.2 g XU8282, 1 g DICY, and 0.67 g 2 MI. Specimens were prepared and analyzed as for example 1. The results are tabulated in Table 2.

All the above examples showed very high Tg and the brittleness due to the incorporation of benzoxazine, which could form a highly cross-linked system.

### Example 4 and Example 5

Varnish samples for Example 4 and Example 5 were prepared according to the formulations listed in Table 1. Specimens were analyzed using the procedure of example 1. The results are shown in Table 2. Results of Examples 3 to 5 indicated that with the increase of ET001 in the formulation, the specimens became more flexible and really showed excellent overall properties, including high Tg, good flexibility, and low CTE. The addition of OP935 led to samples to pass the UL94 VTM-0 test.

TABLE 2

| | Properties | | | | | | |
|---|---|---|---|---|---|---|---|
| | Storage | | Tensile | Elongation | Tensile | | |
| | Modulus | | Strength | at Break | Module | CTE | UL 94 |
| Example No. | (MPa) | Tg (° C.) | (MPa) | (%) | (MPa) | (ppm/° C.) | VTM-0 |
| Ex. 1 | 900 | 240 | Brittle | | | — | — |
| Comp Ex. 1 | 205 | 250 | Brittle | | | — | — |
| Comp Ex. 1a | 1197 | 247 | Brittle | | | 110 | — |
| Ex. 2 | 1102 | 240 | Brittle | | | 127 | — |
| Ex. 3 | 680 | 235 | 22 | 47 | 579 | 131 | — |
| Ex. 4 | 777 | 231 | 22 | 11 | 673 | 133 | Fail |
| Ex. 5 | 898 | 226 | 19 | 7 | 761 | 117 | Pass |

For examples 6-12, DER332 was incorporated neat; DER664, DER669, and EPON-164 were used as 50 wt % solutions.

### Examples 6, 7, 9, and 10

Varnish samples were prepared by combining the components (shown in Table 3) in a well-sealed glass bottle and mixing on rollers at about 1-5 rpm. Varnish solutions were coated by hand drawing with a metal rod or a doctor blade on the treated side of ½ oz/ft² copper foil (Nikko BHY 22BT, black treatment) with the goal of producing 0.001-inch thick films after drying and curing. The wet coatings were dried and cured at 160° C. during one hour.

TABLE 3

| | Raw Material Solution Wt (g) | | | | | | | | |
|---|---|---|---|---|---|---|---|---|---|
| | Epoxy | | | | | Tougher | | Cat. Solution | |
| Ex. No. | DER 332 | DER664 | DER669 | DEN 439 | EPON164 | ET 001RJ | AT 002RJ | Dicy | 2-MI |
| 6A | | 10.0 | | | | 89.9 | | 0.34 | 0.14 |
| 6B | | 19.8 | | | | 80.2 | | 0.68 | 0.28 |
| 6C | | 30.2 | | | | 70.3 | | 0.99 | 0.41 |
| 6D | | 37.2 | | | | 60.4 | | 1.24 | 0.51 |
| 7A | 10.0 | | | | | 89.5 | | 1.91 | 0.79 |
| 7B | 20.1 | | | | | 79.6 | | 3.30 | 1.37 |
| 7C | 30.0 | | | | | 70.6 | | 4.32 | 1.79 |
| 7D | 40.3 | | | | | 59.9 | | 5.19 | 2.15 |
| 8A | 5.7 | | | | | 144.7 | | | |
| 8B | 12.6 | | | | | 143.2 | | | |
| 8C | 30.4 | | | | | 131.5 | | | |
| 8D | 40.1 | | | | | 62.1 | | | |
| 8E | 18.4 | | | | | 124.0 | | 2.59 | 0.85 |
| 8F | 17.4 | | | | | 114.0 | | 0.78 | 0.28 |
| 9A | 36.0 | | | 3.9 | | 59.6 | | 3.50 | 1.45 |
| 9B | 32.0 | | | 8.1 | | 59.6 | | 3.14 | 1.30 |
| 9C | 28.0 | | | 12 | | 59.7 | | 2.78 | 1.15 |
| 9D | 23.9 | | | 16 | | 59.4 | | 2.44 | 1.01 |
| 10A | 18.2 | | | | 1.9 | 29.6 | | 4.10 | 1.70 |
| 10B | 15.9 | | | | 3.9 | 30.8 | | 4.21 | 1.74 |
| 10C | 14.2 | | | | 16.3 | 30.0 | | 4.57 | 1.89 |
| 10D | 11.9 | | | | 17.9 | 30.9 | | 4.65 | 1.92 |
| 11A | 18.0 | | | | 4.0 | 85.7 | | 3.33 | 1.38 |
| 11B | 16.0 | | | | 8.0 | 85.7 | | 3.52 | 1.46 |
| 11C | 14.0 | | | | 12.0 | 85.7 | | 3.70 | 1.53 |
| 11D | 12.0 | | | | 16.0 | 85.7 | | 3.88 | 1.61 |
| 11aA | 18.0 | | | | 4.0 | 85.7 | | 3.33 | 1.38 |
| 11aB | 16.0 | | | | 8.0 | 85.7 | | 3.52 | 1.46 |
| 11aC | 14.0 | | | | 12.0 | 85.7 | | 3.70 | 1.53 |
| 11aD | 12.0 | | | | 16.0 | 85.7 | | 3.88 | 1.61 |
| 12A | 19.5 | | | | 10.0 | 48.6 | 24.3 | 4.32 | 1.79 |
| 12B | 19.5 | | | | 10.0 | 42.9 | 30.0 | 4.32 | 1.79 |
| 12C | 19.0 | | | | 10.0 | 37.1 | 37.1 | 4.24 | 1.75 |
| 12D | 19.5 | | | | 10.0 | 24.3 | 48.6 | 4.32 | 1.79 |
| 12aA | 19.5 | | | | 10.0 | 48.6 | 24.3 | 4.32 | 1.79 |
| 12aB | 19.5 | | | | 10.0 | 42.9 | 30.0 | 4.32 | 1.79 |
| 12aC | 19.0 | | | | 10.0 | 37.1 | 37.1 | 4.24 | 1.75 |
| 12aD | 19.5 | | | | 10.0 | 24.3 | 48.6 | 4.32 | 1.79 |

Copper was removed from the coated foils by ammoniacal etching and the resulting cured, free-standing dielectric films were conditioned at 50±5% relative humidity and 23±2° C. (ASTM D 618-00) for at least 12 hours before thermal or physical analysis. Films were analyzed by TMA (ISO 11359-2, IPC-TM-650 §2,4,41,3 & §2.4.24.3) in the temperature range of 0 to 250° C. with a temperature ramp rate of 5° C./minute; the CTE was measured in the very linear 0-60° C. portion of the curve; Tg was estimated as the intersection of the extrapolations of the linear portions of the curves before and after the Tg. Most films failed by stretching to the maximum range of the grip extension at 110 to 125° C. DMA was used between −25 to 250° C. at a temperature ramp rate of 20° C./min) to measure the modulus of the films at 25° C. and the Tg. Films remained intact during these analyses. Tensile testing specimens were prepared (ASTM D 6287-05) with a 0.500-inch Thwing-Albert strip shear. All data were recorded in Table 4.

### Examples 8-12

Compositions were prepared as in Example 6 except that the drying was performed at 110° C. for 60 minutes. Curing occurred during press lamination at 175° C. and 300 psi during 60 minutes in two constructions: symmetrical DS construction wherein two coated and dried foils were laminated coating-to-coating at 175° C. and 300 psi during 60 minutes and asymmetrical wherein the composition-coated side of a coated and dried foil was press laminated to the treated side of an uncoated copper foil, also at 175° C. and 300 psi during 60 minutes. These are designated S or A, respectively, in Table 4. Some laminated specimens were post-baked at 225° C. after press lamination at 175° C. These can be identified in Table 4 by the entry in the T (° C.) column. For the laminated specimens, adhesion was measured by 90° peel strength (Method IPC-TM-650 §2.4.9). Pertinent analysis results were recorded in Table 4 in lines corresponding to the cure conditions.

Examples 9-11 show properties with added Novolac.

Example 12 shows a mixture of ET001 and AT002.

TABLE 4

| | | | | | Coated side* | | Laminated | | Tensile | |
|---|---|---|---|---|---|---|---|---|---|---|
| | | | | | | After | side* | | UTS | Modulus |
| Ex. No. | T (° C.) | T (min) | Type | S or A | As is | solder | As is | ** | (MPa) | (Gpa) |
| 6A | 160 | 60 | SS | | | | | | 41.1 | 1.17 |
| 6B | 160 | 60 | SS | | | | | | | |
| 6C | 160 | 60 | SS | | | | | | 39.2 | 1.23 |
| 6D | 160 | 60 | SS | | | | | | 46.6 | 1.39 |
| 7A | 160 | 60 | SS | | | | | | 32.3 | 0.788 |
| 7B | 160 | 60 | SS | | | | | | 39.9 | 1.08 |
| 7C | 160 | 60 | SS | | | | | | 42.6 | 1.08 |
| 7D | 160 | 60 | SS | | | | | | 48.7 | 1.24 |
| 8A | 175 | 60 | DS | A | | | | P | | |
| 8B | 175 | 60 | DS | A | | | | P | | |
| 8C | 175 | 60 | DS | A | | | | P | | |
| 8D | 175 | 60 | DS | A | | | | | | |
| 8E | 175 | 60 | DS | A | | | | P | | |
| 8F | 175 | 60 | DS | A | | | | F | | |
| 9A | 160 | 60 | SS | | | | | P | 42.4 | 2.17 |
| 9B | 160 | 60 | SS | | | | | P | 43.3 | 2.21 |
| 9C | 160 | 60 | SS | | | | | P | 44.1 | 2.03 |
| 9D | 160 | 60 | SS | | | | | P | 41.6 | 1.86 |
| 9A | 175 | 60 | DS | S | 4.6 | | | | | |
| 9B | 175 | 60 | DS | S | 4.5 | 5.3 | | | | |
| 9C | 175 | 60 | DS | S | 4.5 | | | | | |
| 9D | 175 | 60 | DS | S | 4.4 | 5.1 | | | | |
| 10A | 160 | 60 | SS | | | | | | 45.7 | 2.14 |
| 10B | 160 | 60 | SS | | | | | | 47.9 | 2.32 |
| 10C | 160 | 60 | SS | | | | | | 46.7 | 1.19 |
| 10D | 160 | 60 | SS | | | | | | 43.3 | 1.05 |
| 10A | 175 | 60 | DS | S | 4.8 | | | | | |
| 10B | 175 | 60 | DS | S | 4.6 | | | | | |
| 10C | 175 | 60 | DS | S | 4.3 | | | | | |
| 10D | 175 | 60 | DS | S | 4.4 | | | | | |
| 10A | 225 | 60 | DS | S | | | | | | |
| 10B | 225 | 60 | DS | S | | | | | | |
| 10C | 225 | 60 | DS | S | | | | | | |
| 10D | 225 | 60 | DS | S | | | | | | |
| 11A | 175 | 60 | DS | A | | | | | | |
| 11B | 175 | 60 | DS | A | | | | | 40.3 | 1.06 |
| 11C | 175 | 60 | DS | A | | | | | 39.8 | 0.993 |
| 11D | 175 | 60 | DS | A | | | | | 37.8 | 0.909 |
| 11aA | 175 | 60 | DS | A | 9.3 | | 9.7 | P | | |
| 11aB | 175 | 60 | DS | A | | | | P | | |
| 11aC | 175 | 60 | DS | A | 8.9 | | 8.7 | P | | |
| 11aD | 175 | 60 | DS | A | 5.9 | | 4.8 | P | | |
| 11aA | 225 | 60 | DS | A | 9.3 | | 9.5 | P | | |
| 11aB | 225 | 60 | DS | A | 9.1 | | 10.1 | P | | |
| 11aC | 225 | 60 | DS | A | 10.4 | | 7.3 | P | | |
| 11aD | 225 | 60 | DS | A | 10.6 | | 7.7 | P | | |
| 12A | 175 | 60 | DS | A | 3.8 | | 3.8 | P | 30.4 | 0.953 |
| 12B | 175 | 60 | DS | A | 3.1 | | 3.5 | P | | |
| 12C | 175 | 60 | DS | A | | | | P | 25.8 | 1.2 |
| 12D | 175 | 60 | DS | A | 3.0 | | 3.4 | P | 46.5 | 1.38 |
| 12aA | 175 | 60 | DS | A | 6.3 | | 5.6 | P | 46.5 | 1.38 |
| 12aB | 175 | 60 | DS | A | 4 to 8 | | 4.1 | F | 18.7 | 1.11 |
| 12aC | 175 | 60 | DS | A | 4 to 8 | | 4 to 8 | F | 31.4 | 1.05 |

| | | | | | | | | | |
|---|---|---|---|---|---|---|---|---|---|
| 12aD | 175 | 60 | DS | A | DESTR | 3.6 | P | 9.7 | 0.594 |

| | | | DMA | | | | |
|---|---|---|---|---|---|---|---|
| | Elongation | | Mod | | TMA | | Thickness |
| Ex. No. | % (ave) | % (max) | 25° C. | Tan d | Tg | CTE | (mil) |
| 6A | 5.2 | 5.7 | 700 | 106.43 | 112.7 | 95.5 | 0.02 |
| 6B | | | 1000 | 105.95 | 104.9 | 121.3 | |
| 6C | 4.81 | 5.74 | 400 | 101.67 | 99.7 | 70.8 | |
| 6D | 5.15 | 5.77 | 1750 | 95 | 94.7 | 87.5 | |
| 7A | 9.44 | 28.8 | 300 | 141.94 | 132 | 118 | |
| 7B | 6.5 | 7.6 | 1025 | 153.09 | | | |
| 7C | 6.19 | 6.22 | 2200 | 156.42 | 150 | 78.3 | |
| 7D | 6.96 | 10.8 | 1050 | 159.71 | 157 | 72.6 | |
| 8A | | | 281 | 149 | | | |
| 8B | | | 857 | 131 | | | |
| 8C | | | 603 | 99 | | | |
| 8D | | | | | | | |
| 8E | | | 676 | 122 | | | |
| 8F | | | 901 | 141 | | | |
| 9A | 4.17 | 4.2 | 600 | 166.07 | | | 1.76 |
| 9B | 5.78 | 10.1 | | 168.3 | | | 1.97 |
| 9C | 5.94 | 7.91 | 300 | 181.4 | | | 1.91 |
| 9D | 7.29 | 17.7 | | | | | 1.89 |
| 9A | | | 1010 | 137.9 | | | 1.97 |
| 9B | | | 900 | 140.3 | | | 2.04 |
| 9C | | | 1050 | 137 | | | 2.97 |
| 9D | | | | | | | 3.34 |
| 10A | 4.99 | 5.87 | | | | | 1.83 |
| 10B | 5.15 | 6.92 | | | | | 2.04 |
| 10C | 5.83 | 7.09 | | | | | |
| 10D | 6.29 | 7.68 | | | | | 2.03 |
| 10A | | | 450 | 140.23 | | | 2.41 |
| 10B | | | 900 | 135.47 | | | 1.75 |
| 10C | | | 1060 | 147.85 | | | 1.89 |
| 10D | | | 1060 | 162.5 | | | 1.82 |
| 10A | | | 3767 | 159.55 | | | 2.41 |
| 10B | | | 1342 | 177.41 | | | 1.75 |
| 10C | | | 1697 | 168.45 | | | 1.89 |
| 10D | | | 1161 | 161.11 | | | 1.82 |
| 11A | | | | | | | |
| 11B | 8.15 | 8.87 | | | | | |
| 11C | 16.5 | 23 | | | | | |
| 11D | 13.9 | 22.3 | | | | | |
| 11aA | | | 1010 | 132.9 | | | |
| 11aB | | | 550 | 139.1 | | | 1.6 |
| 11aC | | | 170 | 146.1 | | | 1.5 |
| 11aD | | | 810 | 150.2 | | | 1.9 |
| 11aA | | | 815 | 132.9 | | | |
| 11aB | | | 503 | 133.8 | | | |
| 11aC | | | 1037 | 142.6 | | | |
| 11aD | | | 1616 | 152.4 | | | |
| 12A | 4.85 | 4.9 | 864.2 | 116.2 | | | |
| 12B | | | 2723 | 118.88 | | | 1.6 |
| 12C | 4.76 | 8.19 | | | | | |
| 12D | 7.56 | 9.4 | 747.3 | 108.42 | | | 1.2 |
| 12aA | 7.56 | 9.4 | | | | | 0.5 |
| 12aB | 1.79 | 1.96 | 1759 | 118.92 | | | 0.8 |
| 12aC | 3.27 | 3.66 | 2528 | 109.96 | | | 0.6 |
| 12aD | 3.9 | | 1787 | 93.58 | | | 0.6 |

*Nikko BHY-22BT
** Solder Float, Pass (P) or Fail (F)

### Examples 13-18

Varnish solutions were prepared using the procedure of Example 1 and the components shown in Table 5. Results of analyses are also shown in Table 5.

These examples show the dramatic effects of OP935 on the flammability of the composition and the minimal effect on properties such as peels and tensile properties. There was a slight decrease of Tg and a gradual increase of modulus as more OP935 was added.

TABLE 5

| | Ex. 13 | Ex. 14 | Ex. 15 | Ex. 16 | Ex. 17 | Ex. 18 |
|---|---|---|---|---|---|---|
| Components, g | | | | | | |
| ET-001RJ | 200 | 200 | 200 | 200 | 200 | 200 |
| DER664 | 20 | 20 | 20 | 20 | 20 | 20 |
| EPON 164 | 40 | 40 | 40 | 40 | 40 | 40 |
| Exolit OP 935 | 0 | 5 | 10 | 15 | 20 | 25 |
| Sig5840 | 0 | 0.075 | 0.150 | 0.225 | 0.300 | 0.375 |
| Dicy | 6 | 6 | 6 | 6 | 6 | 6 |
| 2-MI | 2 | 2 | 2 | 2 | 2 | 2 |
| Properties | | | | | | |
| Total Burn Time (sec) | 243 | 266 | 92 | 28 | 18 | 14 |
| UL VTM-0 | Fail | Fail | Fail | Pass | Pass | Pass |
| Peels (Tr Cu) (pli) | 5.2 | 7.2 | 7.0 | 6.3 | 6.7 | 6 |
| Tg (C) | 174 | 167 | 170 | 164 | 164 | 157 |
| Storage Modulus (MPa) | 1277 | 1318 | 1464 | 1611 | 1818 | 1849 |
| Tensile Strength (MPa) | 43 | 41 | 42 | 40 | 37 | 35 |
| Elongation (%) | 27 | 19 | 40 | 12 | 30 | 7 |
| Modulus (MPa) | 1321 | 1196 | 1200 | 1471 | 1454 | 1583 |

### Examples 19-24

Varnish solutions were prepared using the procedure of Example 1 and the components shown in Table 6. Results of analyses are also shown in Table 6.

These examples mainly studied the effects of the ET001 epoxy (DER664/EPON164) ratio on various properties of the composition. Results in Table 8 show that with the increase of ET001:epoxy, the Tg of the composition increased in a linear fashion. All these blends showed the single Tg which suggesting these compositions totally miscible. Also with the increase of the ET001/epoxy ratio, the modulus became lower, the elongation became higher, and the CTE became higher. The increase of the elongation and the decrease of the modulus were due to the decrease of the cross-linking when less epoxy resins were used.

TABLE 6

| | Ex. 19 | Ex. 20 | Ex. 21 | Ex. 22 | Ex. 23 | Ex. 24 |
|---|---|---|---|---|---|---|
| Component, g | | | | | | |
| ET-001RJ | 171 | 200 | 228 | 257 | 271 | 286 |
| EPON 164 | 40 | 30 | 20 | 20 | 10 | |
| DER 664 | 40 | 30 | 20 | 10 | | |
| Exolit OP 935* | 20 | 20 | 20 | 20 | 20 | 20 |
| Sig5840 | 0.3 | 0.3 | 0.3 | 0.3 | 0.3 | 0.3 |
| Dicy | 6 | 6 | 6 | 6 | 6 | |
| 2-MI | 2 | 2 | 2 | 2 | 2 | |
| Property | | | | | | |
| Flammability | VTM-0 | VTM-0 | VTM-0 | — | — | VTM-0 |
| Peels (Tr) (pli) | 6.9 | 8.0 | 6.0 | 3.7 | 6.3 | 3.3 |
| Tg (DMA) (C) | 157 | 163 | 177 | 180 | 199 | 214 |
| DMA Modulus | 1899 | 1653 | 1357 | 1235 | 598 | 571 |
| (MPa) | | | | | | |
| Tensile | 36 | 33 | 30 | 28 | 22 | 18 |
| Strength | | | | | | |
| (MPa) | | | | | | |
| Elongation (%) | 12 | 38 | 60 | 93 | 109 | 92 |
| Tensile | 1454 | 1232 | 1109 | 775 | 521 | 498 |
| Modulus | | | | | | |
| (MPa) | | | | | | |
| CTE (X-Y) | 126 | 136 | 132 | 162 | 151 | 180 |
| (ppm/C) | | | | | | |

### Examples 25-29

Varnish solutions were prepared using the procedure of Example 1 and the components from Table 7. Results of analyses are also shown in Table 7.

These experiments show the effect of epoxy type and level on Tg, and other properties in an ET001 based system that includes ET001, epoxy resins, OP935, and cure agents. All of these examples show good properties desirable for circuit material applications: such as UL94 VTM-0 rating, high copper bonds (peels), high Tg, excellent tensile properties, relatively low CTE in a wide temperature range (30-150° C.).

TABLE 7

| | Ex. 25 | Ex. 26 | Ex. 27 | Ex. 28 | Ex. 29 |
|---|---|---|---|---|---|
| Component, g | | | | | |
| ET-001RJ | 200 | 200 | 200 | 200 | 200 |
| EPON 165 | 40 | 30 | 20 | 40 | 40 |
| DER 664 | 20 | 30 | 40 | 20 | |
| DER 684-40E | | | | 20 | 20 |
| Exolit OP 935* | 20 | 20 | 20 | 20 | 20 |
| Sig5840 | 0.3 | 0.3 | 0.3 | 0.3 | 0.03 |
| Dicy | 6 | 6 | 6 | 6 | 6 |
| 2-MI | 2 | 2 | 2 | 2 | 2 |
| Property | | | | | |
| UL Flammability | VTM-0 | VTM-0 | VTM-0 | VTM-0 | VTM-0 |
| Peels (Tr) (pli) | 6.5 | 8.0 | 7 | 8.6 | 9.3 |
| Tg (DMA) (C) | 163 | 163 | 157 | 165 | 179 |
| DMA Modulus (MPa) | 1638 | 1653 | 1695 | 1517 | 1159 |
| Tensile Strength (MPa) | 35 | 33 | 38 | 35.4 | 35.1 |
| Elongation (%) | 35.7 | 37.7 | 6.4 | 44.4 | 32.0 |
| Modulus (MPa) | 1219 | 1232 | 1532 | 1412 | 1289 |
| CTE (X-Y) (ppm/C) | 133 | 151 | 151 | 140 | 151 |

### Examples 30-35

Varnish solutions were prepared using the procedure of Example 1 and the components of Table 8. Results of analyses are also shown in Table 8.

These experiment show the superiority of ET001 resin over the other Vylomax resins for this application.

TABLE 8

| | Ex. 30 | Ex. 31 | Ex. 32 | Ex. 33 | Ex. 34 | Ex. 35 |
|---|---|---|---|---|---|---|
| Component, g | | | | | | |
| ET-001 | 200 | | | | | 100 |
| AT-007RJ | | 280 | | | 140 | 140 |
| AT-008RJ | | | 233 | | | |
| ET-009RJ | | | | 280 | 140 | |
| DER664 | 30 | 30 | 30 | 30 | 30 | 30 |
| EPON 164 | 30 | 30 | 30 | 30 | 30 | 30 |
| Exolit OP 935* | 20 | 20 | 20 | 20 | 20 | 20 |
| Sig5840 | 0.3 | 0.3 | 0.3 | 0.3 | 0.3 | 0.3 |
| Dicy | 6 | 6 | 6 | 6 | 6 | 6 |
| 2-MI | 2 | 2 | 2 | 2 | 2 | 2 |
| Property | | | | | | |
| UL | VTM-0 | VTM-0 | VTM-0 | VTM-0 | VTM-0 | VTM-0 |
| Flammability | | | | | | |
| Tg (DMA) | 163 | Brittle | Brittle | 173 | 162 | 161 |
| (° C.) | | | | | | |
| DMA Modulus | 3395 | Brittle | Brittle | 4039 | 1769 | 3543 |
| (MPa) | | | | | | |
| Tensile | 26 | Brittle | Brittle | 27 | Brittle | 23 |
| Strength | | | | | | |
| (MPa) | | | | | | |
| Elongation (%) | 42 | Brittle | Brittle | 9 | Brittle | 5 |
| Tensile | 685 | Brittle | Brittle | 818 | Brittle | 947 |
| Modulus | | | | | | |
| (MPa) | | | | | | |
| CTE (X-Y) | 127 | 131 | Brittle | 135 | 127 | 111 |
| (ppm/C) | | | | | | |

### Example 36-39

Compositions were prepared using the procedure of Example 8 using components in Table 9; results are tabulated in Table 10.

The results of these experiments show the dramatic range Tg modulus and elongation obtained with varying levels of BPAM-01H, Radel and Gafone.

TABLE 9

| | | Toughener | | | Raw Materials Concentration (%) | | | | Raw Material Solution Wt (g) | | | | | |
|---|---|---|---|---|---|---|---|---|---|---|---|---|---|---|
| | Design % | Radel | | | | Toughener | | | | Toughener | | | Cat. Solution | |
| | Epoxy | A- | BPAM- | | Epoxy | Radel A- | BPAM- | | Epoxy | Radel A- | BPAM- | | Wt (g) | |
| Ex. No. | DER332 | 105NT | 01H | Gafone | DER332 | 105N | 01H | Gafone | DER332 | 105NT | 01H | Gafone | Dicy | 2-MI |
| 36A | 10 | | 90 | | 100 | | 20 | | 5 | | 225 | | 0.788 | 0.327 |
| 36B | 20 | | 80 | | 100 | | 20 | | 10 | | 200 | | 1.576 | 0.653 |
| 36C | 30 | | 70 | | 100 | | 20 | | 15 | | 175 | | 2.364 | 0.980 |
| 36D | 40 | | 60 | | 100 | | 20 | | 20 | | 150 | | 3.152 | 1.307 |
| 36E | | | 100 | | 100 | | 20 | | | | 250 | | | |
| 37A | 20 | 80 | | | 100 | 30.25 | | | 10 | 132.2 | | | 1.576 | 0.980 |
| 37B | 40 | 60 | | | 100 | 30.25 | | | 20 | 99.2 | | | 3.152 | 1.307 |
| 37C | 60 | 40 | | | 100 | 30.25 | | | 30 | 66.1 | | | 4.728 | 1.960 |
| 37D | 80 | 20 | | | 100 | 30.25 | | | 40 | 33.1 | | | 6.304 | 2.613 |
| 37E | 100 | | | | 100 | 30.25 | | | 50 | | | | 7.880 | 3.267 |
| 37F | | 100 | | | 100 | 30.25 | | | | 165.3 | | | | |
| 38A | 10 | | | 90 | 100 | | | 20 | 5 | | | 225 | 0.788 | 0.327 |
| 38B | 20 | | | 80 | 100 | | | 20 | 10 | | | 200 | 1.576 | 0.653 |
| 38C | 30 | | | 70 | 100 | | | 20 | 15 | | | 175 | 2.364 | 0.980 |
| 38D | 40 | | | 60 | 100 | | | 20 | 20 | | | 150 | 3.152 | 1.307 |
| 38E | | | | 100 | 100 | | | 20 | | | | 250 | | |
| 39A | 10 | | | 90 | 100 | | | 40 | 5 | | | 112.5 | 0.788 | 0.327 |
| 39B | 20 | | | 80 | 100 | | | 40 | 10 | | | 100 | 1.576 | 0.653 |
| 39C | 30 | | | 70 | 100 | | | 40 | 15 | | | 87.5 | 2.364 | 0.980 |
| 39D | 40 | | | 60 | 100 | | | 40 | 20 | | | 75 | 3.152 | 1.307 |
| 39E | | | | 100 | 100 | | | 40 | | | | 125 | | |

TABLE 10

| | | | | | | Tensile | | | | | | | |
|---|---|---|---|---|---|---|---|---|---|---|---|---|---|
| | | | | | | Modu- | | | | | DMA | | |
| | | | | | Solder | lus | UTS | Elongation | | TGA temp. of | Mod | | |
| Ex. No. | T (° C.) | T (min) | Coated* | Laminated* | Float, P or F | (Gpa) | (MPa) | % (ave) | % (max) | 5% Wt. Loss | 25° C. | Tan δ | Tan δ |
| 36A | 175 | 60 | 1.6 | 1.6 | minor F | 0.375 | 35 | 105.027 | 132.7 | | 489.9 | 189.31 | |
| 36B | 175 | 60 | 1.44 | 1.6 | minor F | 0.41 | 27.7 | 69.006 | 81.3 | | 483.5 | 179.8 | |
| 36C | 175 | 60 | 4.8 | 3.2 | minor F | 0.606 | 33.8 | 37.039 | 44.9 | | 910.8 | 171.54 | |
| 36D | 175 | 60 | 0 | 0 | minor F | 0.786 | 41 | 24.414 | 36.9 | | 1067 | 166.77 | |
| 36E | 175 | 60 | 1.92 | 2.08 | minor F | 0.324 | 30.7 | 230.406 | 259.1 | | 465.1 | 202.7 | |
| 37A | 140 | 60 | | | | | | | | 329.2 | | | 219 |
| 37B | 140 | 60 | | | | | | | | 362.4 | | | 202 |
| 37C | 140 | 60 | | | | | | | | 342.1 | | 135.5 | 201 |
| 37D | 140 | 60 | | | | | | | | 350.4 | | 141.7 | 202.4 |
| 37E | | | | | | | | | | 481.9 | | | |
| 37F | 175 | 60 | 1.13 | 1.01 | | | | | | | | | |
| 37A | 175 | 60 | 2.19 | 2.13 | | | | | | | | | |
| 37B | 175 | 60 | 2.55 | 0.35 | | | | | | | | | |
| 37C | 175 | 60 | 3.2 | 0 | | | | | | | | | |
| 37D | | | | | | | | | | | | | |
| 37E | | | | | | | | | | | | | |
| 37F | 240 | 60 | 2.1 | 1.76 | | | | | | | | | |
| 37A | 240 | 60 | 2.7 | 1.44 | | | | | | | | | |
| 37B | 240 | 60 | 3.2 | 2.7 | | | | | | | | | |
| 37C | 240 | 60 | 3.5 | 1.8 | | | | | | | | | |
| 37D | | | 4 | 4.8 | | | | | | | | | |
| 37E | | | | | | | | | | | | | |
| 37F | 175 | 60 | | | | | | | | | 1966 | 125.8 | 154.3 |
| 38B | 175 | 60 | | | | | | | | | 2296 | 154.5 | 168.2 |
| 38C | 175 | 60 | | | | | | | | | 345.2 | 180.2 | |
| 38D | 175 | 60 | | | | | | | | | 385.3 | 206.05 | |
| 39A | 175 | 60 | | | F | | | | | | 1428 | 160.5 | 192.4 |
| 39B | 175 | 60 | | | F | | | | | | 2156 | 131.6 | 158.2 |
| 39C | 175 | 60 | | | P | | | | | | 2164 | 184 | |
| 39D | 175 | 60 | | | P | | | | | | 1939 | 203 | |
| 39E | 175 | 60 | | | F | | | | | | 2605 | 141.8 | 168 |

### Examples 40A, 40B, 41, Comparative Examples 40 and 41

Table 11 lists examples and comparative examples where fillers were used in the compositions. Varnishes were prepared following the procedure of Example 1. Testing results of these examples are also shown in Table 11. The results illustrated the beneficial effects by additions of certain fillers. Examples 40A and 40B show that with the addition of small amount of a talc filler, the CTE was moderately reduced in comparison with Comp Ex. 40. Example 41 shows that the addition of a nano silica filler significantly reduced the CTE and improved other physical properties in comparison with Comp Ex. 41.

TABLE 11

| | Ex. 40A | Ex. 40B | Comp. Ex. 40 | Ex. 41 | Comp. Ex. 41 |
|---|---|---|---|---|---|
| Component, g | | | | | |
| ET-001 | 228 | 228 | 228 | 200 | 200 |
| DER664 | 20 | 20 | 20 | | 30 |
| EPON 164 | 20 | 20 | 20 | 30 | 30 |
| Exolit OP 935 | 20 | 20 | 20 | 17.5 | 17.5 |
| Microtuff AG 609 | 5 | 10 | | | |
| Nanopox E 470 | | | | 50 | |
| Sig 5840 | 0.3 | 0.3 | | 0.3 | |
| Dicy | 6 | 6 | 6 | 6 | 6 |
| 2-MI | 2 | 2 | 2 | 2 | 2 |
| Properties | | | | | |
| UL Flammability | VTM-0 | VTM-0 | VTM-0 | — | — |
| Peels (Tr) (pli) | 5.7 | 7.3 | 8.0 | 8.0 | 4.6 |
| Modulus (DMA) (MPa) | 1268 | 1318 | 1340 | 2030 | 1770 |
| Tg (DMA) (° C.) | 172 | 170 | 164 | 193 | 152 |
| Tensile Strength (MPa) | 25 | 28 | 25 | 38 | 33 |
| Elongation (%) | 48 | 42 | 49 | 14 | 47 |
| Tensile Modulus (MPa) | 906 | 1090 | 1005 | 1226 | 1269 |
| CTE (X/Y) (ppm/C) | 119 | 119 | 143 | 80 | 124 |

The singular forms “a,” “an,” and “the” include plural referents unless the context clearly dictates otherwise. The endpoints of all ranges reciting the same characteristic or amount are independently combinable and inclusive of the recited endpoint. All references are incorporated herein by reference.

While specific embodiments have been shown and described, various modifications and substitutions can be made thereto without departing from the spirit and scope of the invention. Accordingly, it is to be understood that the present invention has been described by way of illustration and not limitations.

What is claimed is:

1. A composition for the manufacture of a circuit material, comprising
a solvent composition having a boiling point below 160° C.; and
a curable composition comprising
an epoxy compound having
an average epoxy functionality of greater than one,
an epoxy equivalent weight of less than about 6,000 Daltons,
a softening point of less than about 160° C., and
solubility in the solvent composition;
an aromatic polymer co-curable with the epoxy compound, and having solubility in the solvent composition; and,
optionally, a catalyst for the epoxy cure.

2. The composition of claim 1, wherein the solvent composition has a boiling point of about 80 to 160° C.

3. The composition of claim 1, wherein the epoxy compound has an average epoxy equivalent weight of about 110 to about 5,000 Daltons.

4. The composition of claim 1, wherein the epoxy compound has an average epoxy equivalent weight of about 170 to about 3,000 Daltons.

5. The composition of claim 1, wherein the epoxy compound has on average of 1.1 to 5 epoxy groups per molecule.

6. The composition of claim 1, wherein the epoxy compound has on average of 1.8 to 4 epoxy groups per molecule.

7. The composition of claim 1, wherein the epoxy compound is a novolac resin.

8. The composition of claim 1, wherein the epoxy compound is a mixture of liquid and solid novolac epoxies.

9. The composition of claim 1, wherein the aromatic polymer has a Tg of greater than about 150° C.

10. The composition of claim 1, wherein the aromatic polymer has a Tg of about 150 to about 200° C.

11. The composition of claim 1, wherein the aromatic polymer is a poly(sulfone), poly(ethersulfone), poly(imide), poly(amide), poly(amide-imide), poly(arylene ether), poly(phenylene ether), poly(phenylquinoxaline), poly(quinoline), poly(arylene ether ketone), poly(arylene ether sulfone), poly(arylene ether phosphone), poly(phosphone), polycarbonate, aromatic poly(ester), or a combination comprising at least one of the foregoing aromatic polymers.

12. The composition of claim 1, wherein the aromatic polymer is a poly(imide), a poly(amide), a poly(amideimide), a poly(ether ether ketone), or a combination comprising at least one of the foregoing aromatic polymers.

13. The composition of claim 1, wherein the aromatic polymer has primary amine, secondary amine, isocyanate, hydroxyl, carboxyl, anhydride, mercapto, thiirane, epoxide, or a combination comprising at least one of the foregoing functional groups.

14. The composition of claim 1, wherein the catalyst is a tertiary amine, an aromatic heterocyclic amine, or a cyano-modified guanidine or amidine.

15. The composition of claim 1, wherein the catalyst is an alkyl-substituted imidazole, dicyandiamide, or a combination thereof.

16. The composition of claim 1, wherein the catalyst is a latent catalyst.

17. The composition of claim 16, wherein the latent catalyst is encapsulated.

18. The composition of claim 17, wherein the encapsulated catalyst is a primary or a secondary amine.

19. The composition of claim 1, comprising about 10 to about 90 wt. % of the solvent composition, about 10 to about 90 wt. % of a curable composition, each based on the combined weight of the solvent composition and the curable composition.

20. The composition of claim 1, wherein the curable composition comprises about 5 to about 40 wt. % of the epoxy, and about 60 to about 95 wt % of the aromatic polymer, each based on the total weight of the curable composition.

21. The composition of claim 1, wherein further comprising a filler system.

22. The composition of claim 1, further comprising up to about 50 wt. % of the filler system, based on the weight of the curable composition.

23. The composition of claim 21, wherein the filler is an inorganic filler.

24. The composition of claim 23, wherein the filler comprises a metal silicate, a metal oxide, or a combination comprising at least one of the foregoing fillers.

25. The composition of claim 24, wherein the metal is magnesium, titanium, or a combination comprising at least one of the foregoing metals.

26. The composition of claim 25, wherein the filler comprises talc, silica, fumed silica, sol-gel nano-sized silica, sol-gel nano-sized silica reinforced organic resin concentrates, or a combination comprising at least one of the foregoing fillers.

27. The composition of claim 1, further comprising a reinforcing system.

28. The composition of claim 27, further comprising up to about 40 wt. % of the reinforcing system, based on the weight of the curable composition.

29. The composition of claim 27, wherein the reinforcing system comprises glass fibers.

30. The composition of claim 27, wherein the reinforcing system comprises a woven or non-woven glass cloth.

31. The composition of claim 1, further comprising a flame retardant.

32. The composition of claim 31, wherein the flame retardant system is present in an amount of up to 40 wt. % of the curable composition.

33. The composition of claim 31, wherein the flame retardant system consists of non-halogenated flame retardants.

34. The composition of claim 31, wherein the flame retardant comprises a flame retardant metal oxide, a phosphorous metal salt, or a combination comprising at least one of the foregoing flame retardants.

35. The composition of claim 31, wherein the flame retardant is an aluminum phosphinate.

36. A circuit material, comprising the cured product of a composition comprising
an epoxy compound having an average epoxy functionality of greater than one, an epoxy equivalent weight of less than about 6,000 Daltons, and a softening point of less than about 160° C.;
an aromatic polymer co-curable with the epoxy compound; and,
optionally, a catalyst for the polymerization of epoxy groups, wherein prior to cure, the epoxy compound, aromatic polymer, and optional catalyst are soluble in a solvent composition having a boiling point below 160° C.

37. The circuit material of claim 36, having a Tg of greater than about 150° C.

38. The circuit material of claim 36, having a single Tg.

39. The circuit material of claim 36, having an elongation of greater than about 10%.

40. The circuit material of claim 36, wherein the material passes IPC chemical resistance test IPC-TM-650 §2.3.2.

41. A circuit laminate comprising a layer of the cured composition of claim 31.

42. The circuit laminate of claim 41, wherein the layer of the cured composition is a bond ply.

43. A circuit comprising a layer of the circuit laminate of claim 36.

44. A method for the manufacture of a circuit laminate, comprising
layering the circuit of claim 43 and another circuit material to provide a stack; and
laminating the stack at about 120 to about 220° C. at about 50 to 500 psi.

45. An article for the manufacture of a circuit material, comprising
a substrate; and
a layer of a curable composition disposed on the substrate, wherein the curable composition comprises
an epoxy compound having an average epoxy functionality of greater than one, an epoxy equivalent weight of less than about 6,000 Daltons, and a softening point of less than about 160° C.;
an aromatic polymer co-curable with the epoxy compound; and,
optionally, a catalyst for the polymerization of epoxy groups, wherein the epoxy compound, aromatic polymer, and optional catalyst are soluble in a solvent composition having a boiling point below 160° C.

46. The article of claim 45, wherein the substrate is a release layer.

47. The article of claim 45, wherein the substrate is a dielectric circuit layer.

48. The article of claim 45, wherein the substrate is an electrically conductive layer.

49. The article of claim 45, wherein the substrate is a copper foil.

50. The article of claim 45, wherein the substrate is an electrically and thermally conductive layer.

51. The article of claim 45, wherein the substrate is a fibrous web.

52. The article of claim 45, wherein the solvent composition has been substantially removed from the curable composition.

53. The article of claim 45, wherein the curable composition is partially cured.

54. The article of claim 45, wherein the solvent composition has been substantially removed from the curable composition and the curable composition is partially cured.

55. The article of claim 45, wherein the solvent composition has been at least substantially removed from the curable composition and the curable composition is fully cured.

56. The article of claim 45, wherein the layer of the fully cured composition has a thickness of about 2 to about 100 micrometers.

57. A circuit laminate comprising the article of claim 55.

58. A circuit comprising the article of claim 55.

59. A multilayer circuit comprising the article of claim 44.

60. A method for the manufacture of a circuit laminate, comprising
layering the article of claim 55 and a circuit material to provide a stack; and
laminating the stack at about 120 to about 220° C. at about 50 to 500 psi.

61. A method for the manufacture of a circuit material, comprising
disposing a layer of the composition of claim 1 onto a substrate;
removing the solvent composition; and
curing the curable composition.

62. The method of claim 60, wherein the curing is partial curing.

63. The method of claim 60, wherein the partial curing occurs at the same time as removing the solvent composition.

64. The method of claim 60, wherein the curing is full curing.
